(19) United States
(12) Patent Application Publication
(10) Pub. No.: US 2016/0065984 A1
(43) Pub. Date: Mar. 3, 2016

(54) SYSTEMS AND METHODS FOR PROVIDING DIGITAL VIDEO WITH DATA IDENTIFYING MOTION

(71) Applicants: Farzad Nejat, San Francisco, CA (US); Siau-Way Liew, Pinole, CA (US)

(72) Inventors: Farzad Nejat, San Francisco, CA (US); Siau-Way Liew, Pinole, CA (US)

(21) Appl. No.: 14/841,924

(22) Filed: Sep. 1, 2015

Related U.S. Application Data
(60) Provisional application No. 62/045,115, filed on Sep. 3, 2014.

(51) Int. Cl. H04N 19/51; H04N 5/14; G06F 17/30; G06T 7/20

(52) U.S. Cl. CPC H04N 19/51; G06T 7/2093; H04N 5/144; G06F 17/30781; G06T 2207/10016

(57) ABSTRACT

A method for providing digital video with data identifying motion, includes: recording digital video data during an action of an activity from an imager to a first memory within the camera as recorded digital video, wherein the camera is coupled to a person performing an action or to an object used by the person to perform the action; recording motion data from a movement sensor as the action is performed by a person or by an object used by the person during the activity along with the recorded digital video, wherein the movement sensor is coupled to the person performing the action or to the object used by the person to perform the action; automatically analyzing the motion data with a processor of the camera to detect a motion; adding a detected motion of the automatically analyzing as first metadata to the recorded digital video stored in the first memory; and validating the first metadata as motion of the activity.

This invention claims the benefit of U.S. Provisional Patent Application No. 62/045,115 filed on Sep. 3, 2014, which is hereby incorporated by reference in its entirety.

### BACKGROUND OF THE INVENTION

Digital video cameras are well known in the art, and therefore will not described herein in detail. Still, it should be understood that some conventional digital video cameras have accelerometers disposed therein. Due to the integration of a silicon-based accelerometer chip into digital video cameras, measurements in more than one axis are possible. Both dynamic and static acceleration can be measured in several directions at the same time.

By measuring static acceleration from two perpendicular axes, the precise degree of both roll and pitch for a digital video camera can be determined. This is typically used to make sure that the images on the display screens of the camera are always displayed upright. For example, such motion data can be used to seamlessly transition a display screen between a portrait mode and a landscape mode.

By measuring or recording dynamic acceleration (vibration) during the time of image capture, a baseline signal can be captured. Such a baseline signal can be used to actively stabilize the captured image through an electronic counter movement of a virtual recording frame using software to result in a stabilized recorded image. The need to reduce image shake or image blur has necessitated the need to put accelerometers into digital video cameras that are capable of multi-axial sensing at high digital sampling rates for image processing purposes. Thus, the accelerometers within digital video cameras are capable of routinely outputting both static and dynamic acceleration data.

To reduce power consumption of the digital video camera, the output of the accelerometer can be monitored to put the camera into sleep mode and even turn off the camera. For example, if no movement of the digital video camera is detected for 10 minutes, the digital video camera goes into a sleep mode in which the imaging apparatus of the digital video camera is turned off. Then, if no movement of the digital video camera is detected for 20 minutes, the digital video camera is turned off. Other than image orientation, image stabilization and/or power management, accelerometer output is not otherwise utilized in current digital video cameras.

### SUMMARY OF THE INVENTION

Accordingly, the invention is directed toward systems and methods for providing digital video from a camera with data identifying motion.

An object of the invention is to provide a system having an imaging apparatus, a processor, a memory and a movement sensor to identify a motion of a specific activity so as to create recorded digital video with data identifying the motion in the digital video.

Another object of the invention is to provide a method of using an imaging apparatus, a processor, a memory and a movement sensor to identify a motion of a specific activity so as to create recorded digital video with data identifying the motion in the digital video.

Additional features and advantages of the invention will be set forth in the description which follows, and in part will be apparent from the description, or may be learned by practice of of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described, a method for providing digital video with data identifying motion, includes: recording digital video data during an action of an activity from an imager to a first memory within the camera as recorded digital video, wherein the camera is coupled to a person performing an action or to an object used by the person to perform the action; recording motion data from a movement sensor as the action is performed by a person or by an object used by the person during the activity along with the recorded digital video, wherein the movement sensor is coupled to the person performing the action or to the object used by the person to perform the action; automatically analyzing the motion data with a processor of the camera to detect a motion; adding a detected motion of the automatically analyzing as first metadata to the recorded digital video stored in the first memory; and validating the first metadata as the motion for the activity.

In yet another aspect, a method for providing digital video with data identifying motion includes: recording digital video data during an activity from an imager to a first memory within the camera as recorded digital video; recording motion data from a movement sensor as the action is performed by a person or by an object used by the person during the activity along with the recorded digital video in the first memory, wherein the movement sensor is coupled to the person performing the action or to the object used by the person to perform the action; automatically analyzing the motion data with a processor to detect a motion during the activity; adding a detected motion of the automatically analyzing as first metadata to the recorded digital video; adding second metadata to the recorded digital video; and validating the first metadata as a motion of the activity based on the second metadata.

In yet another aspect, a system for providing digital video with data identifying motion, includes: an imager for recording digital video data of an action performed by a person during an activity to a first memory within the camera; a motions sensor for recording motion data along with the recorded digital signal as the action is performed by a person or by an object used by the person during the activity, wherein the movement sensor is coupled to the person performing the action or to the object used by the person to perform the action; a first memory within the camera for storing the digital video data from the imager and the motion data from the movement sensor; a first processor within the camera to automatically analyze the motion data to detect a first motion, which corresponds to one of a plurality of reference motion patterns stored in the first memory, during the activity and to add first and second metadata to the recorded digital video stored in the first memory during the activity, wherein the first metadata designates an interval within the recorded digital video corresponding to the detected first motion; and a second processor using the second metadata to validate the first metadata as a motion of the activity.

It is to be understood that both the foregoing general description and the following detailed description are exemplary and explanatory and are intended to provide further explanation of the invention as claimed.

### BRIEF DESCRIPTION OF THE DRAWINGS

The invention will be described with reference to the following drawing figures, in which like numerals represent like items throughout the figures, and in which:

FIG. 1 is a perspective view of a wireless movement sensor accessory and a digital video camera coupled to an end of a surfboard for explaining the invention.

FIG. 2 is a block diagram of an exemplary architecture of the components within the digital video camera shown in FIG. 1.

FIG. 3 is for explaining an implementation of the invention in the block diagram of FIG. 2 for the digital video camera shown in FIG. 1 using an internal accelerometer of the digital video camera.

FIG. 4 is for explaining an implementation of the invention in the block diagram of FIG. 2 for the digital video camera shown in FIG. 1 using an external accelerometer.

FIG. 5 is for explaining an implementation of the invention in the block diagram of FIG. 2 for the digital video camera shown in FIG. 1 using both an internal accelerometer of the digital video camera along with an external accelerometer.

FIG. 6 is for explaining an implementation of the invention in the block diagram of FIG. 2 for the digital video camera together with a computer/smartphone.

FIG. 7 is for explaining an implementation of the invention in the block diagram of FIG. 2 for the digital video camera and an external accelerometer together with a computer/smartphone.

FIG. 8 is a flow diagram of an exemplary method for providing digital video with data identifying motion.

FIG. 9a is a representation of a digital video file having metadata for an identified motion.

FIG. 9b is a representation of a digital video file having metadata for a validated identified motion.

FIG. 10 depicts how validated identified motion is specified in relation to an interval of a frame sequence from a recorded digital video having metadata for an identified motion.

FIG. 11 is a flow diagram of an exemplary method for creating a reference motion pattern.

FIG. 12 is an illustration that is useful for understanding how a reference motion pattern is created.

FIG. 13 depicts an exemplary device used for synchronization of a digital video track and a sensor track.

FIG. 14 is a graph showing motion data from a movement sensor as a sensor track.

### DETAILED DESCRIPTION OF THE INVENTION

It will be readily understood that the components of the invention as generally described herein and illustrated in the appended figures could be arranged and designed in a wide variety of different configurations. Thus, the following more detailed description of various examples of the invention, as represented in the figures, is not intended to limit the scope of the present disclosure, but is merely representative of various implementations of the invention. While the various aspects of the invention are presented in drawings, the drawings are not necessarily drawn to scale unless specifically indicated.

The invention may be employed in other specific forms without departing from its spirit or essential characteristics. The following descriptions are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Further, the described features, advantages and characteristics of the invention may be combined in any suitable manner. One skilled in the relevant art will recognize, in light of the description herein, that the invention can be practiced without one or more of the specific features or advantages. In other instances, additional features and advantages may be recognized in certain implementations of the invention that may not be present in other implementations of the invention.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

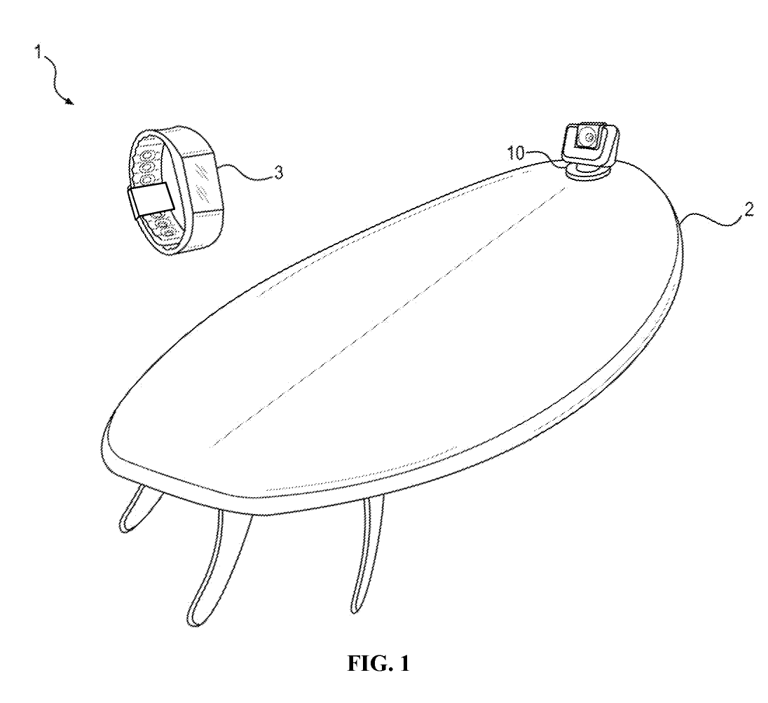

FIG. 1 is a perspective view of a wireless movement sensor accessory and a digital video camera coupled to an end of a surfboard for explaining the invention. As shown in FIG. 1, a system 1 can include a surfboard 2 with a digital video camera 10 coupled to the front end of the surf board. Further, the system 1 can also include a wireless movement sensor accessory 3. In this example, the digital video camera 10 is mounted to face the user so as to record the user as the surfboard 2 undergoes different movements or motions while the user rides the surfboard 2. In the alternative, the digital video camera 10 can face away from a user and record the forward scene in front of the user as the surfboard 2 undergoes different movements or motions while the user rides the surfboard 2.

As shown in FIG. 1, the wireless movement sensor accessory 3 can be a battery-powered accelerometer, which is attached to a transmitter, positioned within a bracelet or anklet The wireless movement sensor accessory 3 can wirelessly transmit motion data or motion data to the digital video camera 10 as well as wirelessly receive controls signals from the digital video camera 10. Both transmission and reception can occur between the digital video camera 10 and the wireless movement sensor accessory 3 with near field communication technologies, such as WiFi or Bluetooth. The wireless movement sensor accessory 3 can be powered by a battery but also can be supplemented with solar energy. To maintain high water resistance, the battery of the wireless movement sensor accessory 3 can be recharged inductively through a waterproof case of the wireless movement sensor accessory 3.

For the activity of surfing, the wireless movement sensor accessory 3 is typically worn as an anklet on the leading leg, since the actions of the leading leg of a surfer can be seen as more indicative of surfing motions by the surfer. In the alternative, the wireless movement sensor can be in a smartwatch or a smartphone attached to a user. The movement sensor measures inertial changes or acceleration of the movement sensor as the movement sensor is moved or in motion. Further, the movement sensor can output the measurements of changes in the movement sensor' inertia or acceleration as motion data. An accelerometer is an exemplary device that can be used as a movement sensor. An accelerometer can measure movement of its motion in a mono-directional, bi-directional or tri-directional manner.

Although surfing is presented as an exemplary activity with regard to FIG. 1, the activity can also be, but not limited to, walking, running, golfing, basketball, biking, skateboarding, roller blading, wakeboarding, tennis, rock climbing, skiing, kayaking, waiting tables, driving, cooking, eating, plumbing work and using a firearm. Further, the digital video camera can be mounted on an object associated with the activity, such as on a cap, handle bars, a skate board, a cap and a helmet. Further, the digital video camera can be mounted to afford a view of the activity, such as on a basketball goal, a tennis net post or an unmanned aerial vehicle with a view of the activity.

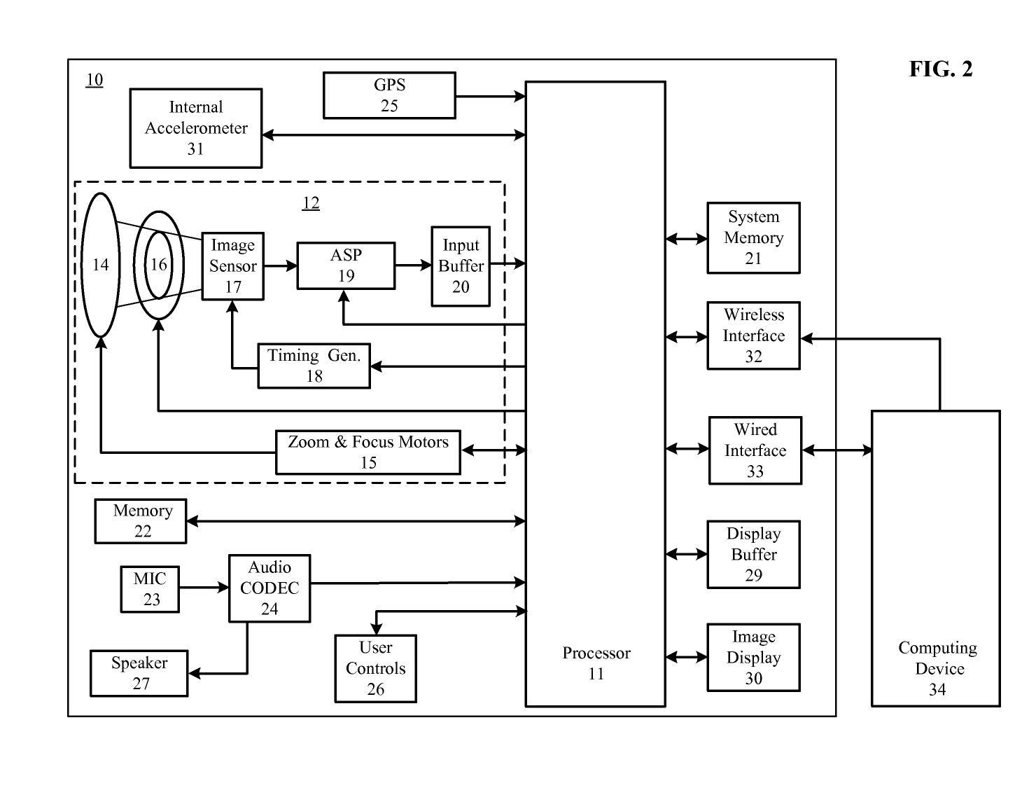

FIG. 2 is a block diagram of an exemplary architecture of the components within the digital video camera shown in FIG. 1. As shown in FIG. 2, the invention can include a digital video camera 10 having a processor 11 that controls an imaging apparatus 12 of the digital video camera 10. The lens 14 of the imaging apparatus 12 has zoom and focus motors 15 controlled by the processor 11. An electronic shutter/aperture 16, which is controlled by the processor 11, is positioned between the lens 14 and the image sensor 17 of the imaging apparatus 12. The image sensor 17 provides an analog video signal in accordance with a timing signal from a timing generator 18, which is controlled by the processor 11. The analog video signal from the imager 17 is provided to an analog signal processor 19, which is controlled by the processor 11, to convert the analog video signal into a digital video data. The instructions or programs for the processor 11 to control the digital video camera 10 are stored in the system memory 21 within the digital video camera 10. An input buffer 20 temporarily stores the digital video data until the processor 11 saves the digital video data as recorded digital video in the memory 22 within the digital video camera 10. In addition to the digital video data, audio received through the microphone 23 and then processed through the audio CODEC 24 can also be saved with or as a part of the recorded digital video in the memory 22 within the digital video camera 10. Furthermore, the location for the digital video data can also be saved in the memory 22 along with the recorded digital video using GPS data from a GPS chip 25 within the digital video camera 10.

As shown in FIG. 2, the digital video camera 10 can include user controls 26 for playing back the recorded digital video in the memory 22 through the speaker 27 and on the image display 30 under the control of the processor 11 using the display buffer 29. Further, the digital video camera 10 can include a wireless interface 32 and wired interface 33 such that a computing device 34 can interface with firmware for the processor 11 in the system memory 21 or download recorded digital video in the memory 22. The internal accelerometer 31 is used for both recording and playing back the recorded digital video in the appropriate orientation.

The invention provides additional applications for the internal accelerometer 31 in the digital video camera 10 and/or an external accelerometer accessed by the digital video camera 10 through the wireless interface 32. That is, motion data is obtained from the internal accelerometer 31, which is used as a movement sensor, disposed within the digital video camera 10 and/or one or more external wireless accelerometer, which is used as a movement sensor, that is mounted on a user in an activity or on an object used by user for an action in the activity. The use of more than one external wireless accelerometer provides more motion data so as to provide higher confidence in appropriately identifying the motion of an action in the activity. The invention can use an imaging apparatus, a processor, a memory and an accelerometer to identify a motion of a specific action in an activity so as to create recorded digital video with data identifying the motion in an interval of the digital video. The identifying of a motion and the creating a recorded digital video with data identifying the motion are automatically performed by the digital video camera 10. No user-software interaction is required to initiate either the identifying the motion or the creating a recorded digital video with data identifying the motion.

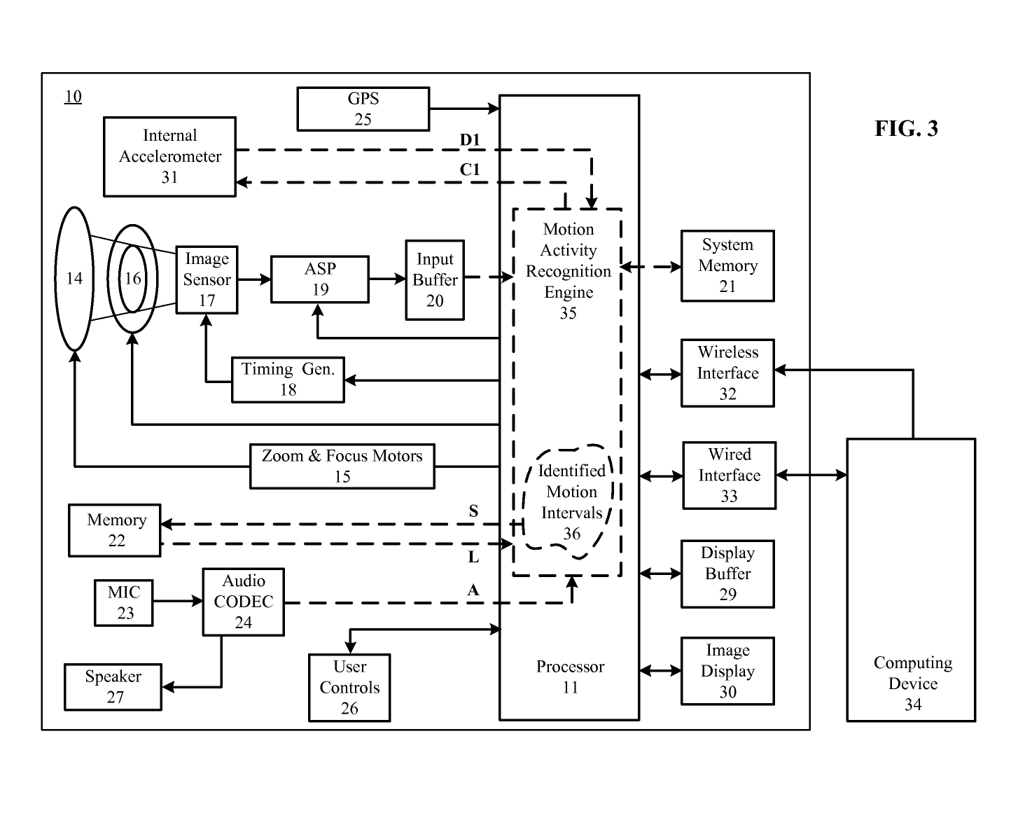

FIG. 3 depicts an implementation of the invention in the block diagram of FIG. 2 for the digital video camera shown in FIG. 1 using an internal movement sensor of the digital video camera. As shown in FIG. 3, a Motion Activity Recognition Engine 35 can be running in the processor 11 from the system memory 21 as the digital video camera 10 is saving S recorded digital video, which can also include audio A from the microphone 23, to memory 22 during an activity. The Motion Activity Recognition Engine 35 provides the internal accelerometer 31, which can be used as a movement sensor, with a control signal C1 such that the internal accelerometer 31 outputs motion data D1 to the processor 11. The control signal C1 can vary the sampling rate of the internal accelerometer 31. The motion data D1 can have varying frequency, varying amplitude and changing slopes.

Then, the Motion Activity Recognition Engine 35 automatically analyzes the varying frequency, the varying amplitude and the changing slopes of the motion data D1 to detect if a motion stored as a reference motion pattern is being performed during the activity. More particularly, the Motion Activity Recognition Engine 35 compares a motion pattern of the varying frequency, the varying amplitude and the changing slopes from the motion data D1 to a plurality of pre-stored reference motion patterns in a library L within the memory 22. If the motion pattern derived from the motion data D1 at least partially matches a corresponding one of the plurality of pre-stored reference motion patterns in a library L within the memory 22, then that motion pattern is detected as the user performing an identified motion corresponding to a motion for that pre-stored reference pattern.

The library L of pre-stored reference motion patterns can be organized such that motions that occur during a particular activity are grouped or stored together in a tree-type or hierarchal structure. For example, a paddling motion recognized as surfing activity could be the basis of subsequent motion recognition in that pre-stored reference motion patterns for surfing would searched first. Thus, the search could be first constrained or directed to the group of pre-stored reference motion patterns of surfing activity so as to both improve detection accuracy and increase speed by reducing the search field for a pre-stored reference motion patterns that may match a motion.

After the Motion Activity Recognition Engine 35 has detected a motion of the user as an identified motion, an interval within the recorded digital video corresponding to the beginning and ending times of the identified motion is designated as an Identified Motion Interval. All of the Identified Motion Intervals 39 can be added to the recorded digital video as metadata. Since there may be more than one identified motion in a recorded digital video or several different identified motions in a recorded digital video, the Motion Activity Recognition Engine 35 may add numerous Identified Motion Intervals 36 as metadata to the recorded digital video.

The motion data D1 can also be saved along with the digital video data in the recorded digital video for subsequent analysis of the motion data D1. Capturing the motion data enables subsequent validation of the Identified Motion Intervals. For example, the pre-stored reference motion patterns in the memory 22 may not have all of the reference motion patterns for all of the actions in the activity or the processor 11 may have determined that a detected motion could be either one of two motions corresponding to two different pre-stored reference motion patterns in the memory 22. The motion data D1, stored with the digital video data in the recorded digital video, could be uploaded to another computing device 34, such as a personal computer or smartphone, so as to be analyzed in comparison to a larger library of reference motion pattern or subjected to signal processing to determine the motion corresponding to a single pre-stored reference motion pattern.

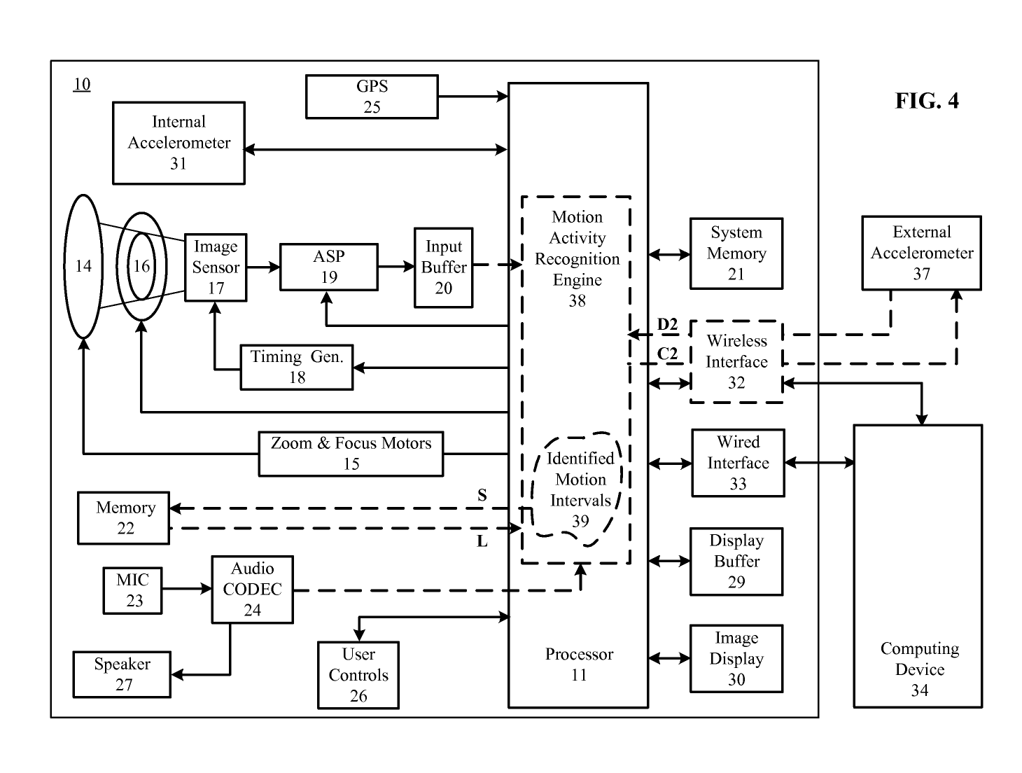

FIG. 4 depicts an implementation of the invention in the block diagram of FIG. 2 for the digital video camera shown in FIG. 1 using an external accelerometer. As shown in FIG. 4, a Motion Activity Recognition Engine 38 can be running in the processor 11 from the system memory 21 as the digital video camera 10 is saving S recorded digital video, which can also include audio A from the microphone 23, to memory 22 during an activity. The Motion Activity Recognition Engine 38 provides the external accelerometer 37 with a control signal C2 through a wireless interface 32 such that the external accelerometer 37 outputs motion data D2 back through the wireless interface 32 to the processor 11 that can have varying frequency, varying amplitude and changing slopes. The control signal C2 can vary the sampling rate of the external accelerometer 37. The motion data D2 can have varying frequency, varying amplitude and changing slopes.

Then, the Motion Activity Recognition Engine 38 automatically analyzes the varying frequency, the varying amplitude and the changing slopes of a waveform of the motion data to detect if a motion stored as a reference motion pattern is being performed during the activity. More particularly, the Motion Activity Recognition Engine 38 compares a motion pattern of the varying frequency, the varying amplitude and the changing slopes of a waveform of the motion data D2 to a plurality of pre-stored reference motion patterns in a library L within the memory 22. If the motion pattern derived from the motion data D2 at least partially matches a corresponding one of the plurality of pre-stored reference motion patterns in a library L within the memory 22, then that motion pattern is detected as the user performing an identified motion corresponding to a motion of that pre-stored reference pattern. After the Motion Activity Recognition Engine 38 has detected an action of the user as an identified motion, an interval within the recorded digital video corresponding to the beginning and ending times of the identified motion. All of the Identified Motion Intervals 39 can be added to the recorded digital video as metadata.

The motion data D2 can also be saved along with the digital video data in the recorded digital video for subsequent analysis of the motion data D2. Although only one external accelerometer is shown in FIG. 4, an additional external accelerometer can be used to identify motions and the motion data from each of the accelerometers can be saved with the digital video data in the recorded digital video. Two external accelerometers can be placed on a same object to be indicative of a motion, such as an external accelerometer on each leg of a surfer, or on two different objects to be indicative of a motion, such as an external accelerometer on a leg of a surfer and another external accelerometer on the surfboard. The motion data from one or more external accelerometers can be averaged together for comparison to pre-stored reference motion patterns or used together for a comparison to pre-stored reference motion patterns based on two such inputs of motion data.

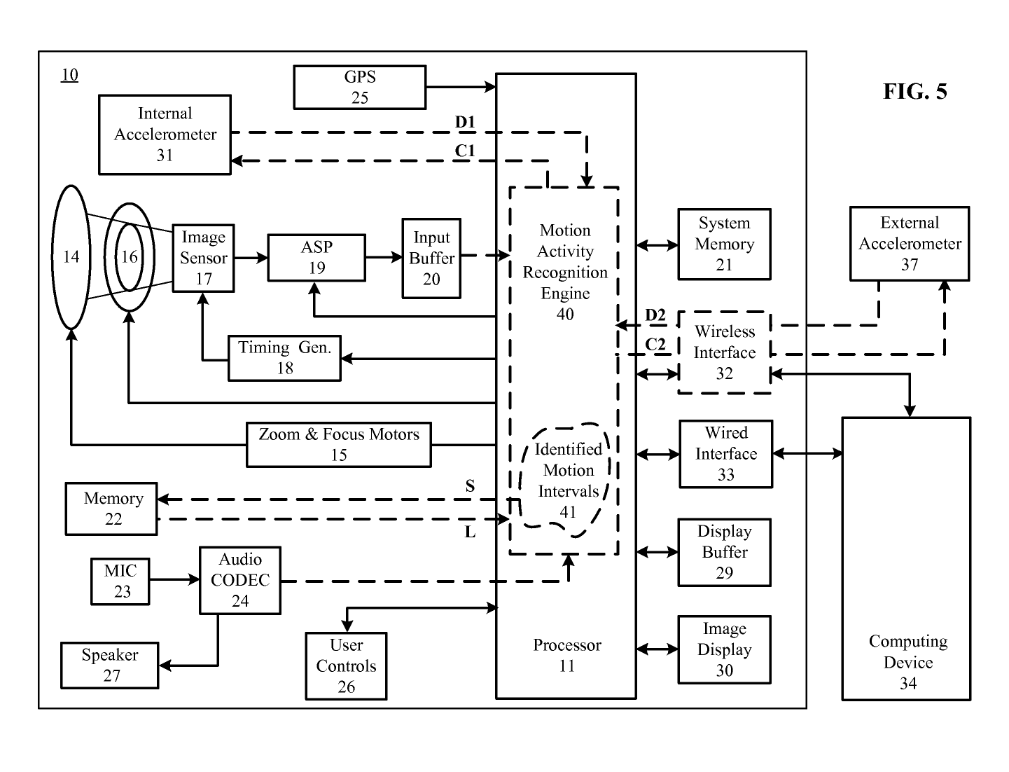

FIG. 5 depicts an implementation of the invention in the block diagram of FIG. 2 for the digital video camera shown in FIG. 1 using both an internal accelerometer of the digital video camera along with an external accelerometer. As shown in FIG. 5, a Motion Activity Recognition Engine 40 can be running in the processor 11 from the system memory 21 as the digital video camera 10 is saving S recorded digital video, which can also include audio A from the microphone 23, to memory 22 during an activity. The Motion Activity Recognition Engine 40 can provide the internal accelerometer 31 with a control signal C1 and can also provide the external accelerometer 37 with a control signal C2 through a wireless interface 32. The internal accelerometer 31 outputs motion data D1 to the processor 11 in response to the control signal C1 and the external accelerometer 37 outputs motion data D2 back through the wireless interface 32 to the processor 11 in response to the control signal C2. The control signals C1 and C2 can vary the sampling rate of the internal accelerometer 31 and the external accelerometer 37, respectively. The motion data D1 and D2 can have varying frequency, varying amplitude and changing slopes.

Then, the Motion Activity Recognition Engine 40 automatically analyzes the varying frequency, the varying amplitude and the changing slopes of the motion data D1 and D2 to detect if a motion stored as a reference motion pattern is being performed during the activity. More particularly, the Motion Activity Recognition Engine 40 compares either an average motion pattern from the motion data D1 and D2 to a plurality of pre-stored reference motion patterns in a library L within the memory 22 or the two motion patterns of the motion data D1 and D2 to a plurality of pre-stored reference motion patterns based on two motion patterns in a library L within the memory 22. If the motion patterns derived from the motion data D1 and D2 at least partially matches a corresponding one of the plurality of pre-stored reference motion patterns in a library L within the memory 22, then those motion patterns are detected as the user performing an identified motion corresponding to a motion of that pre-stored reference pattern. After the Motion Activity Recognition Engine 40 has detected an action of the user as an identified motion, an interval within the recorded digital video corresponding to the beginning and ending times of the identified motion. All of the Identified Motion Intervals 41 can be added to the recorded digital video as metadata.

The motion data D1 and D2 can also be saved along with the digital video data in the recorded digital video for subsequent analysis of each of the motion data D1 and D2. Although only one external accelerometer is shown in FIG. 5, an additional external accelerometer can be used to identify motions and the motion data from each of the accelerometers can be saved with the digital video data in the recorded digital video. The two external accelerometers can be placed on a same object to be indicative of a motion, such as an external accelerometer on each leg of a surfer. The motion data from one or more external accelerometers can be averaged together for use with the internal accelerometer 31 of the digital camera 10.

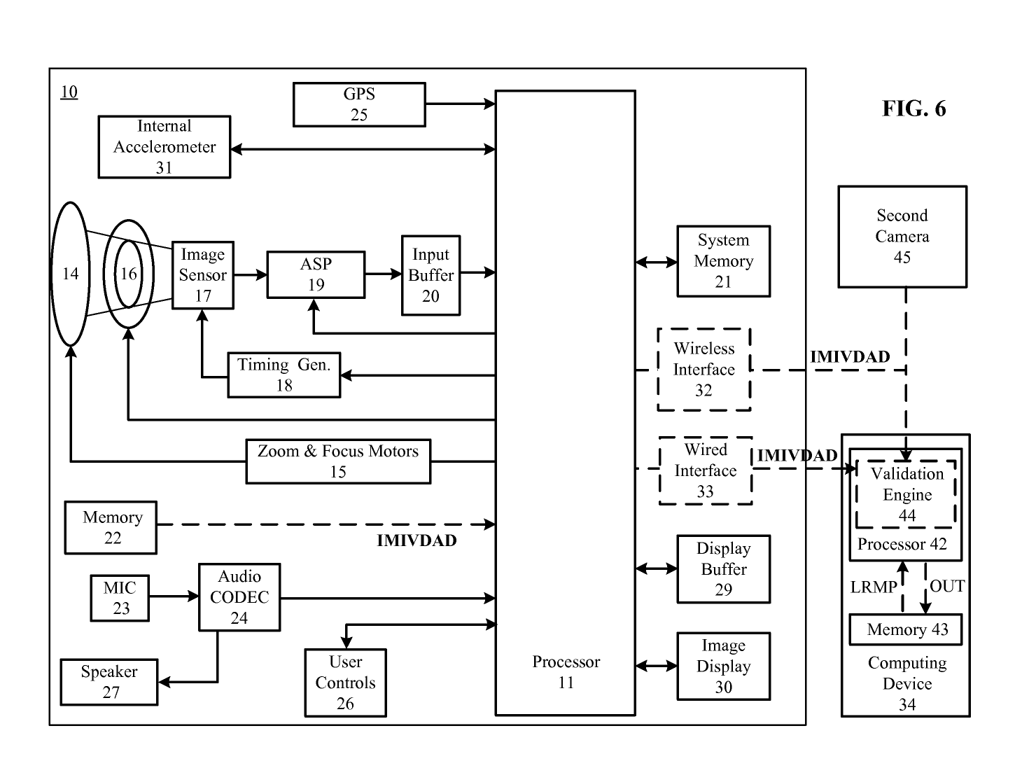

FIG. 6 is for explaining an implementation of the invention in the block diagram of FIG. 2 for the digital video camera together with a computer/smart phone. As shown in FIG. 6, a computing device 34 has a processor 42 and a memory 43. The digital video file IMIVDAD containing Identified Motion Intervals as well as both video data and motion data can be downloaded from the memory 22 of the digital camera 10 into the memory 43 of the computing device 34 through the wired interface 33 or wireless interface 33 of the digital camera 10. A Validation Engine 44 running on the processor 42, as shown in FIG. 6, can be used to verify whether an Identified Motion Interval is a correctly identified motion of an activity based on additional information.

Data from a second digital camera 45 can also be provided to the Validation Engine 44 running on the processor 42. The second camera 45 can have the same or a different perspective of the activity recorded by the other digital camera 10. Further, additional cameras can be used.

The data from the second digital camera 45 can be video data of the same activity recorded in the digital video file IMIVDAD of the other digital camera 10. The video of the second camera can be combined with the digital video file IMIVDAD of the other digital camera 10 such that there is an additional perspective for an Identified Motion Interval are two per. In addition, the data from the second digital camera 45 can also include Identified Motion Intervals that are unique to the second camera due to the positioning or mounting of the second camera 45 for the activity.

The memory 43 of the computing device 34 can contain a library of pre-stored reference motion patterns for a specific activity and reference categorizations of activities based on other criteria, such as geographic location. For example, in a library containing pre-stored reference motion patterns for surfing and pre-stored reference motion patterns for skateboarding, would also have a reference categorization for the activity of surfing as an ocean/sea activity and a reference categorization for the activity of skateboarding as a land activity. In addition to or in the alternative to geographic location, parameters, such as temperature, altitude or speed, can be used for categorization of the activities or as the additional information for the activities. Such a library of pre-stored reference motion patterns each activity and further categorization of each of the activities based on other criteria in concert with a Validation Engine 44 running on the processor 42, as shown in FIG. 6, can be used to verify whether an Identified Motion Interval is a correctly identified motion of an activity based on additional information, such as location information for the recorded activity or an input by the user describing the activity.

If the Identified Motion Intervals are determined to be correctly identified motions of the recorded activity, then the metadata for the Identified Motion Intervals can be marked valid and/or additional metadata can be added describing the activity. Otherwise, the Validation Engine 44 performs a reevaluation of the motion data based on pre-stored reference motion patterns for one or more activities indicated by the additional information to be likely. Then, the metadata is changed to reflect Validated Identified Motion Intervals that are marked as valid and/or additional metadata can be added describing the activity that was validated. Such a validation process can discern between motions appearing to being similar based only motion data but yet are completely different motions of different activities.

The additional information can be an input into the digital video camera 10 from user describing the activity, such as “surfing,” or data from a sensor in the digital video camera 10, such as a GPS 25. The reevaluation can include reanalyzing the motion data based on pre-stored reference motion patterns for the activity, as input by the user, or one or more activities indicated by the additional information to be likely, such sea/ocean activities. Just prior to the reanalyzing of the motion data in the processor 42 of FIG. 6, the Validation Engine 44 can filter noise and other extraneous information from the motion data by running an algorithm to clean-up the motion data. A match is determined when a certain percentage of the motion data is the same as or substantially similar to that a corresponding one of the plurality of pre-stored reference motion patterns for one or more activities indicated by the additional information to be likely. Subsequent to the reevaluation, the metadata for the incorrect Identified Motion Intervals is replaced with metadata for the correct Identified Motion Intervals that can be marked valid and/or have additional metadata added describing the activity. The Validated Identified Motion Intervals can be stored in the memory 43. Although a local computing device 34 is shown in FIG. 6 as having the Validation Engine 44, another computing device (not shown), such as a server accessed through the internet by the local computing device 34, can have the Validation Engine 44 as well as the libraries and filtering algorithms associated with the Validation Engine 44.

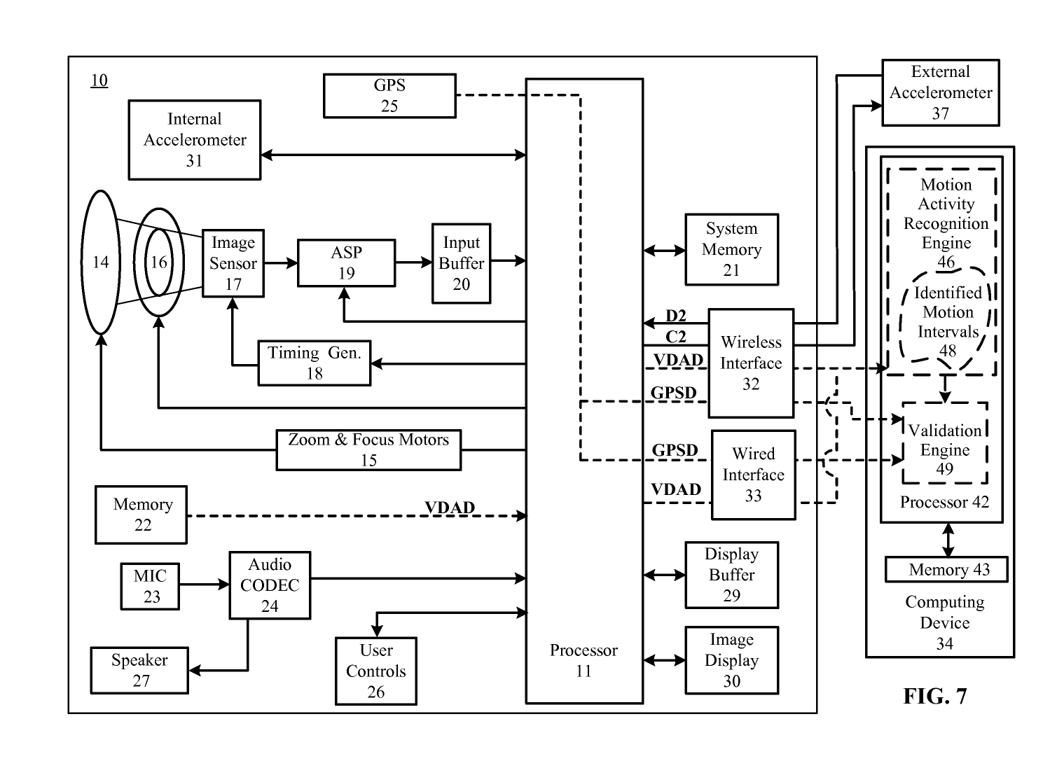

FIG. 7 is for explaining an implementation of the invention in the block diagram of FIG. 2 for the digital video camera and an external accelerometer together with a computer/smartphone. FIG. 7 depicts an implementation of the invention in the block diagram of FIG. 2 for the digital video camera shown in FIG. 1 using an external accelerometer, the digital video camera and a computer/smartphone. As shown in FIG. 7, the external accelerometer 37 outputs motion data D2 back through the wireless interface 32 to the processor 11 in response to the control signal C2 from the processor 11. The Motion Activity Recognition Engine 46 can be running in the processor 42 from the system memory 43 as the digital video camera 10 is saving both recorded digital video and motion data VDAD to the memory 22 during an activity through the wireless interface 32. In the alternative, the Motion Activity Recognition Engine 46 can the recorded digital video and motion data VDAD from the memory 22 after the activity is done through either the wireless interface 32 or the wired interface 33.

The Motion Activity Recognition Engine 46 automatically analyzes the motion data D2 of the recorded digital video and motion data VDAD from the camera 10 to detect if a motion corresponds to a reference motion pattern so as identify the motion as a specific motion being performed during the activity. More particularly, the Motion Activity Recognition Engine 46 compares the motion data D2 to a plurality of pre-stored reference motion patterns in a library L within the memory 43. Each of the motion patterns have a respectively corresponding specific motion of an activity. If the motion pattern derived from the motion data D2 at least partially matches a corresponding one of the plurality of pre-stored reference motion patterns in a library L within the memory 43, then those motion patterns are detected as the user performing an identified motion corresponding to a specific motion of that pre-stored reference pattern. After the Motion Activity Recognition Engine 46 has detected an action of the user as an identified motion, an interval within the recorded digital video corresponding to the beginning and ending times of the identified motion. All of the Identified Motion Intervals 48 can be associated with the recorded digital video as metadata.

A Validation Engine 49 running on the processor 42, as shown in FIG. 7, can be used to verify whether the Identified Motion Intervals 48 are each a correctly identified motion of an activity based on additional information. The memory 43 of the computing device 34 can contain a library of pre-stored reference motion patterns for a specific activity and reference categorizations of activities based on other criteria, such as geographic location. For example, in a library containing pre-stored reference motion patterns for surfing and pre-stored reference motion patterns for skateboarding, would also have a reference categorization for the activity of surfing as an ocean/sea activity and a reference categorization for the activity of skateboarding as a land activity. In addition to or in the alternative to geographic location, parameters, such as temperature, altitude or speed, can be used for categorization of the activities or as the additional information for the activities. Such a library of pre-stored reference motion patterns each activity and further categorization of each of the activities based on other criteria in concert with a Validation Engine 49 running on the processor 42.

As shown in FIG. 7, the Validation Engine 49 can be used to verify whether an Identified Motion Interval is a correctly identified motion of an activity based on additional information, such as location information GPSD from the GPS 25 during the recorded activity. In another alternative, the location information GPSD can be stored along with the VDAD and then later input into the Validation Engine along with the recorded digital video and motion data VDAD. In addition to or in the alternative, location information GPSD, the user can input other information describing or categorizing the activity. Further, information from sensors other than GPS 25 can be additional used to validate, such as a temperature sensor. For example, temperature can be used to differentiate snow skiing from grass skiing in addition to location information.

If the Identified Motion Intervals are determined to correctly identified motions of the recorded activity, then the metadata for the Identified Motion Intervals can be marked valid and/or additional metadata can be added describing the activity. Otherwise, the Validation Engine 44 performs a reevaluation of the motion data based on pre-stored reference motion patterns for one or more activities indicated by the additional information to be likely. Then, the metadata is changed to reflect Validated Identified Motion Intervals that are marked as valid and/or additional metadata can be added describing the activity that was validated. The Validated Identified Motion Intervals can be stored in the memory 43. Such a validation process can discern between actions appearing to being similar based only motion data but yet are completely different motions of different activities. Although only one external accelerometer is shown in FIG. 7, an additional external accelerometer or an internal accelerometer can be used to identify motions and the motion data from each of the accelerometers can be saved with the digital video data in the recorded digital video.

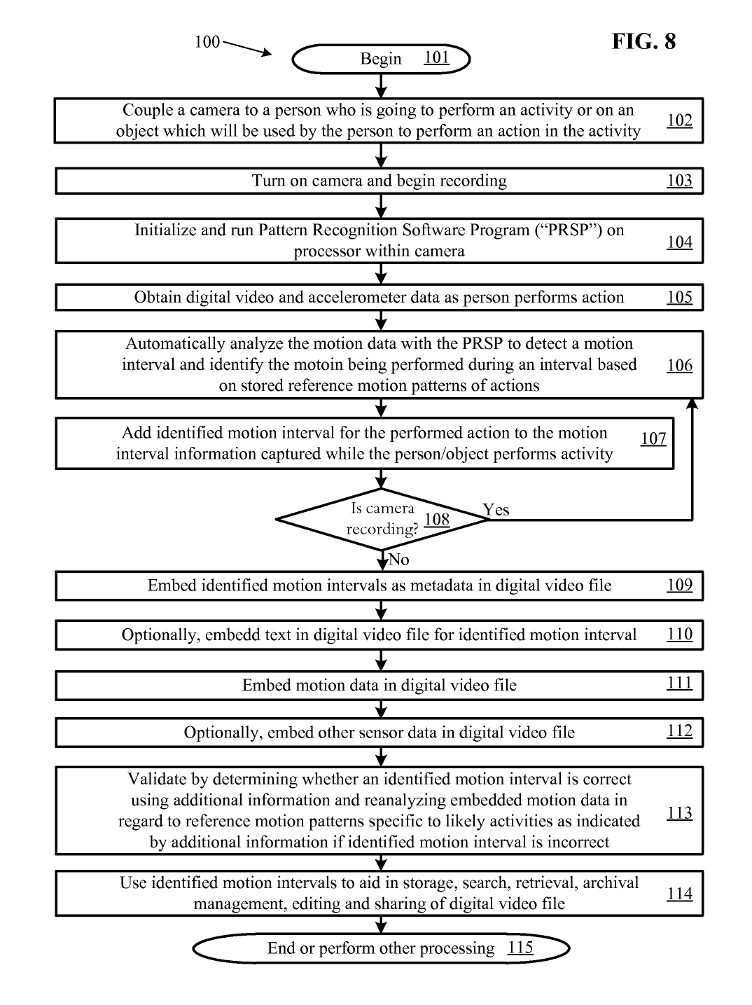

FIG. 8 is a flow diagram of an exemplary method for providing digital video with data identifying motion. The method 100 begins at step 101 and continues with step 102 of coupling either a camera or an accelerometer to a person who is going to perform an activity or to an object which will be used by the person to perform an action in the activity. Notably, motion of the object will be the same as or substantially similar to motion of at least a portion of the person's body while performing an activity. For example, let's assume that the person is surfing and the camera 10, which has an internal accelerometer, is mounted on the tip of the surf board 2, as shown in FIG. 1. In this case, the surf board 2 and person (not sown) constitute a single active unit. As such, the motion of the camera while the person is surfing a wave will be the same as at least the feet of that person. The pattern of the camera's motion is unique and identifiable, and therefore the internal accelerometer within the camera can be used to detect a motion that a person is performing. This step 101 can include the person putting on a body worn accelerometer in place of or as an addition to the internal accelerometer within the camera. In the exemplary implementation shown in FIG. 1, the body worn accelerometer 3 can be on the ankle of the person since a motion of the ankles surfing a wave will be the same as at least the feet of that person. The body worn accelerometer 3 is wirelessly connected to the digital camera 10 such that the digital camera and the person are not directly connected.

Prior to beginning the activity, the person turns on the camera to begin recording in step 103 of FIG. 8. In response, step 104 is performed in which a Pattern Recognition Software Program (“PRSP”) is initialized and run on a computing device (or processor 11 of FIG. 2) within the digital video camera 10. As the person performs the activity, recorded digital video as well as motion data can be obtained by the digital video camera 10, as shown by step 105.

The motion data is automatically analyze with the PRSP in step 106 of FIG. 8 to detect a motion interval and identify a motion being performed during the interval based on stored reference motion patterns. In this regard, a motion pattern defined by the motion data acquired during a period of time is compared to a plurality of pre-stored reference motion patterns. Each reference motion pattern is associated with a specific or particular motion (e.g., left turn, right turn, 180 turn). If the motion pattern of the motion data matches one of the reference motion patterns more so than other reference motion patterns, the person is deemed to be performing the motion associated with the most closely matching reference motion pattern during an interval having beginning and ending times so as to be an identified motion interval. A match is deemed found when a certain percentage, such as >50%, of the motion data of the motion pattern from the motion data is the same as or substantially similar to that of a particular reference motion pattern. Then, as shown in step 107, an identified motion interval for the performed motion is added to motion interval information captured while the person/object performs the motion. Notably, the motion pattern may be that of the object, and therefore motion of the object can be correlated with an activity of the person and a specific motion performed by the person. Thus, actual motion of the person is not required to be measured for purposes of detecting a specific motion being performed by the person.

If the camera is still recording, as shown in step 108 of FIG. 8, the process continues back to step 106 of the PRSP analyzing motion data to detect a motion interval and identify motion being performed during the motion interval based on stored reference motion patterns. If the camera is no longer recording, as shown in step 108, the identified motion intervals of the motion interval information is embedded as a metadata into the digital video file, as shown in step 109. An identified motion interval is an interval within the recorded digital video corresponding to the beginning and ending times of an identified motion.

Optionally, as shown in step 110 of FIG. 8, text may be embedded into the digital video file related to the identified motion interval within the digital video file. For example, the text saved into the digital video file explains the identified motion being performed by the person as the identified motion occurs in the playback of the digital video.

As shown in step 111 of FIG. 8, motion data can be embedded in the digital video file. The motion data may be later used during a validation process. If the Identified Motion Intervals are not deemed correct, then the motion data is used in a reevaluation to correctly identify motion intervals using motion patterns specific to likely activities as indicated by additional information.

Yet another option, as shown in step 112, other sensor data, such as a GPS location data, can be embedded in the digital video file. Other sensor data can include, but is not limited to, time-series streams of gyroscope data, magnetometer data, barometric data, humidity data, audio signals, temperature data, radar signals, radio signals and laser based measurements related to the scene where the digital video was captured. Accordingly, the digital video file can comprise a motion picture track, an auditory track, a textual track, a motion data track and/or other sensor data tracks, all synchronized with the digital video data. The newly embedded textual information and/or sensor data may or may not be displayed along with the digital video (i.e., the video defined by the motion picture track and auditory track).

As shown in step 113 of FIG. 8, the identified motion can be validated by determining whether an identified motion interval is correct using additional information and reanalyzing embedded motion data in regard to reference motion patterns specific to likely activities as indicated by the additional information if the identified motion interval is incorrect. If the identified motion interval is not correct to a specific activity, the embedded motion data is reanalyzed using only reference motion patterns of a likely activity or activities, as indicated by the additional information. Input from the user or other data within the digital video file can be the additional information. For example, GPS location data embedded within the digital video file can be used to determine whether the recording occurred on land or the sea/ocean. If the GPS location data indicates the sea/ocean, then Identified Motion Intervals indicative to surfboard riding are deemed correct. Had the GPS location data indicated land, the Identified Motion Intervals indicative of surfboard riding would be deemed incorrect and the embedded motion data would be reanalyzed using only reference motion patterns of actions specific to land activities, such as skateboarding, rollerblading or scooter riding. Instead of surfing down a wave, the validated identified motion intervals would be with respect to skateboarding down a ramp.

Notably, other sensor data can be used during the validation process in addition to or in the alternative to GPS locations data. The other sensor data can include, but is not limited to, gyroscope data, magnetometer data, barometric data, humidity data, audio signals, temperature data, radar signals, radio signals and laser based measurements. The other sensor data is an additional tool to further discern the set of pre-stored reference motion patterns of likely activities so as to more effectively identify a motion being a specific action of a specific activity

The identified motion intervals can be used, as shown in step 114 of FIG. 8, to aid in storage, search, retrieval and archival management, editing, and sharing of the digital video. That is, portions of recorded digital video corresponding to a specific identified motion can be searched from an archive of a plurality of recorded digital videos in a plurality of digital video files. In another alternative, a library of a specific identified motion can be formed from an archive of a plurality of recorded digital videos in a plurality of digital video files. In yet another alternative, certain identified motion intervals can be selected to be edited or shared. Upon completing step 115 of FIG. 8, the method 100 ends or other processing is performed.

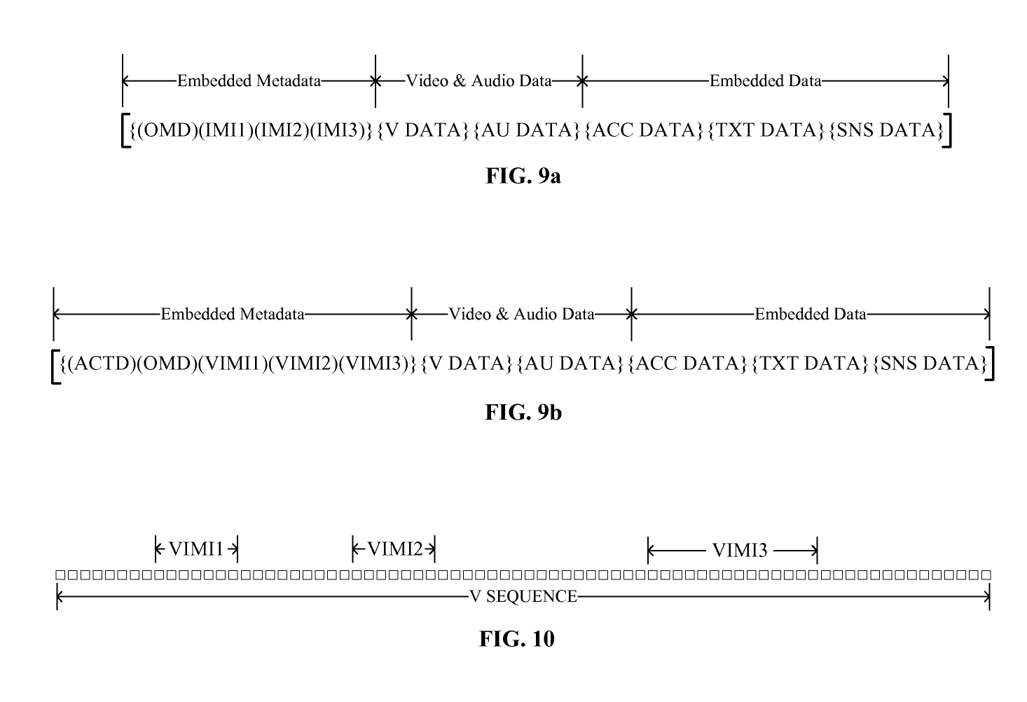

FIG. 9a is a representation of a digital video file having metadata for an identified motion. As shown in FIG. 9a, a digital video file can include metadata OMD, IMI1, IMI2, and IMI3, video data V DATA, audio data AUD DATA and other embedded data, such as motion data ACC DATA, text data TXT DATA and sensor data SNS DATA. The metadata not only includes the metadata for Identified Motion Intervals IMI1, IMI2, and IMI3 but also other metadata OMD associated with the video data V DATA of the digital video file. The other metadata OMD can be additional information used instead of or in addition to the sensor data SNS DATA for validating the Identified Motion Intervals IMI1, IMI2, and IMI3.

FIG. 9b is a representation of a digital video file having metadata for validated identified motion. As shown in FIG. 9b, a digital video file can includes other metadata OMD and Identified Motion Intervals designated as valid VIMI1, VIMI2, and VIMI3 along with the video data V DATA, audio data AUD DATA and other embedded data, such as motion data ACC DATA, text data TXT DATA and sensor data SNS DATA. As a result of validation, additional metadata ACTD can be added that is indicative of the activity to which the identified motion intervals correspond.

FIG. 10 depicts how the validated identified motion is specified in relation to an interval of a frame sequence from a recorded digital video having metadata for an identified motion. As shown in FIG. 10, each of the Identified Motion Intervals IMI1, IM12, and IMI3 correspond to three different periods within the video V SEQUENCE. For example, Identified Motion Interval IMI1 can correspond to a first period within the video V SEQUENCE in which a left turn was made on a surf board, Identified Motion Interval IMI2 can correspond to a second period within the video V SEQUENCE in which a right turn was made on a surf board and Identified Motion Interval IMI3 can correspond to a third period within the video V SEQUENCE in which 180° turn was made on the surf board 2 shown in FIG. 1. In this example, each of the three different Identified Motion Intervals are for different motions. However, each of the three different Identified Motion Intervals could be for the same motion performed at different times.

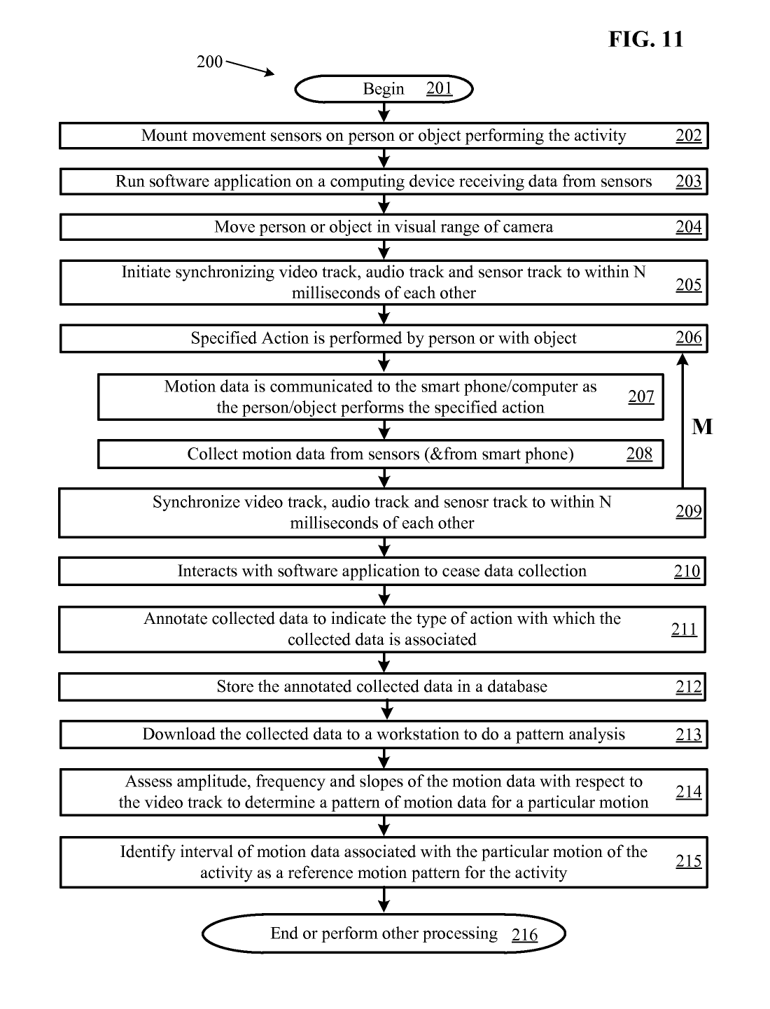

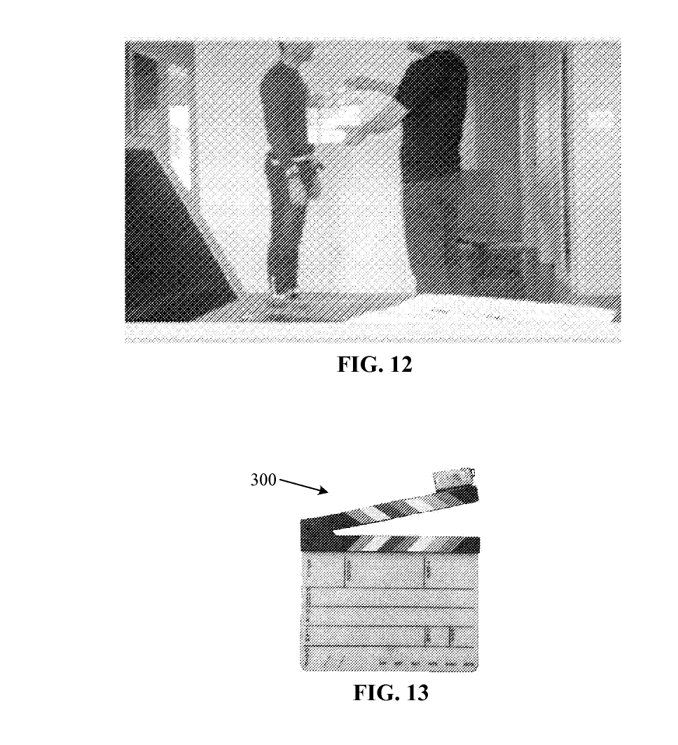

FIG. 11 is a flow diagram of an exemplary method for creating a reference motion pattern. FIG. 12 is an illustration that is useful for understanding how a reference motion pattern is created. Method 200 begins with step 201 of FIG. 11 and continues with step 202, which involves mounting movement sensors on a person and/or object which will be performing an activity. For example, movement sensors that contain an accelerometer can be mounted on the head, wrist, arm, leg, stomach and/or chest of the person. A schematic illustration of a person with such movement sensors mounted thereon is shown in FIG. 12.

Thereafter in step 203, as shown in FIG. 11, a software application is run on a computing device coupled to the person/object in which the computing device receives data from the movement sensors mounted on the person/object. For example, a smart phone is disposed in a back pocket of the person's pants. Next, as shown in step 204, the person/object is moved into visual range of the camera. Then, in step 205, the synchronizing of a video track, an audio track, and sensor track is initiated. The audio/video data and the motion data from the body mounted movement sensors are synchronized within 0-N milliseconds of each other, where N is an integer (e.g., 1). Such accurate time synchronization is made possible using a device.

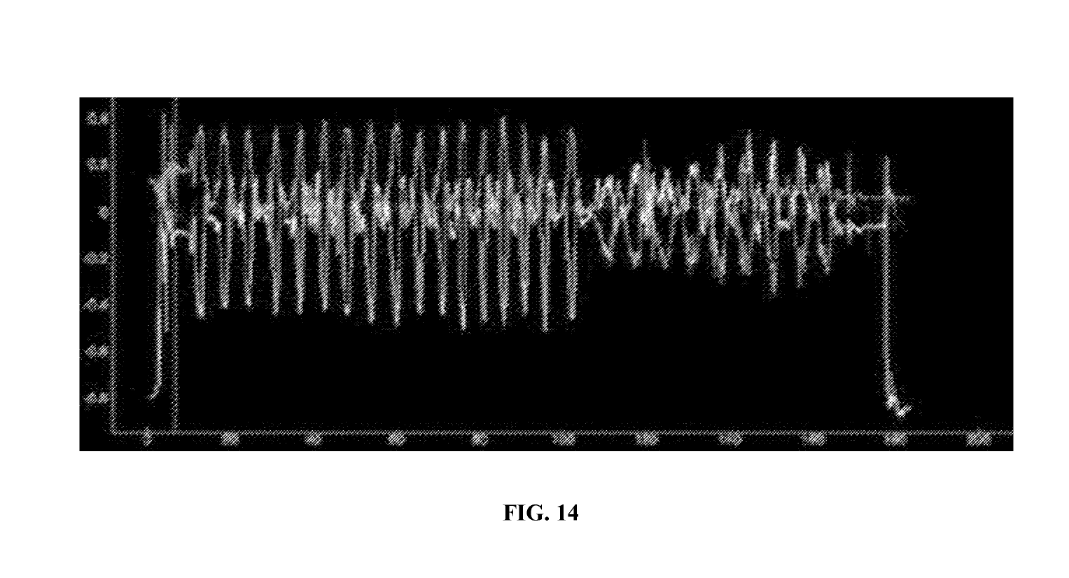

FIG. 13 depicts an exemplary device used for synchronization of a digital video track and a sensor data track. FIG. 14 is a graph showing motion data from a movement sensor as a sensor track. The device 300 is generally an accelerometer clapper board that time synchronizes the motion picture track, the audio track, and the sensor tracks from the body mounted movement sensors. The highly accurate time synchronization allows an operator to visualize the movement of the body in concert with a moving indicator pointing to the corresponding time point by the motion data plotted on a graph in the sensor track. The correct reference motion pattern data for the given activity being performed by the body can then be extracted from the graph. Initiation using the device 300 creates a unique spike in the y-axis of the sensor track, as shown in the graph of FIG. 14. The time difference between when the unique spikes occur and the time point in the video that the tool is seen to be initiated is used to compensate for a difference in the motion data time-stamp and the video frame time-stamp, thus enabling the synchronization of the motion data track to the video track and the audio track.

After initiation in step 205 of FIG. 11, the person or object begins to performs the specified action (e.g. a swings a sports object, picks something up off of the floor, or vertebral flexion and extension), as shown by step 206. Notably, the person or object can repeatedly and iteratively perform the specified action M number of times throughout the step 206, where M is an integer (e.g., 8) to get a comprehensive basis of data for the specified action. As the person/object iteratively performs the activity, motion data is communicated in step 207 from the body mounted movement sensors and/or the object mounted movement sensors to the smart phone. In step 208, the smart phone collects the sensor data from the body mounted movement sensors, as well as from a movement sensor within the smart phone. Once the specified action has been performed M number of times, the device 300 is initiated again to synchronize the stopping of the motion data track to the video track and the audio track, as shown in step 209. User-software interactions can then be performed in step 210 so as to cease the data collecting operations of the software application running on the smart phone.

In step 211 of FIG. 11, the collected data is annotated to indicate the type of movement/action with which the collected data is associated. The annotated collected data is then stored in a remotely located database (e.g., in the cloud of a cloud computing system), as shown in step 212 of FIG. 11. Thereafter, the annotated collected data is downloaded to a workstation for a pattern analysis thereof, as shown in step 213 of FIG. 11. The analysis involves: assessing the amplitude, frequency and slopes of the motion data with respect to the video track to determine a pattern of motion data for a particular motion in the activity; and identifying an interval of the motion data associated with a particular motion of the activity as a reference motion pattern, as shown by steps 214 and 215 of FIG. 11. The identifying an interval of the motion data involves: analyzing the motion data track to identify the start and end of each iteration of the specified action; and parsing the motion data associated with a particular motion of the specific action in the activity; and storing the parsed motion data as a reference motion pattern for the particular motion of the activity. Subsequently, step 216 is performed where method 200 ends or other processing is performed.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described examples. Rather, the scope of the invention should be defined in accordance with the following claims and their equivalents.

What is claimed is:

1. A method for providing digital video with data identifying motion, comprising:
recording digital video data during an action of an activity from an imager to a first memory within a first camera as recorded digital video, wherein the first camera is coupled to a person performing an action or to an object used by the person to perform the action;
recording motion data from a movement sensor as the action is performed by a person or by an object used by the person during the activity along with the recorded digital video, wherein the movement sensor is coupled to the person performing the action or to the object used by the person to perform the action;
automatically analyzing the motion data with a processor of the first camera to detect a motion;
adding a detected motion of the automatically analyzing as first metadata to the recorded digital video stored in the first memory; and
validating the first metadata as motion of the activity.

2. The method according to claim 1, wherein the first metadata designates an interval within the recorded digital video corresponding to the detected motion.

3. The method according to claim 1, where the automatic analyzing comprises:
comparing a motion pattern from the motion data to a plurality of pre-stored reference motion patterns, wherein the pre-stored reference motion patterns are stored in the first memory; and
identifying that the person is performing a first motion as a detected motion when the motion pattern for the first motion at least partially matches a corresponding one of the plurality of pre-stored reference motion patterns.

4. The method according to claim 3, wherein the first metadata designates an interval within the recorded digital video as corresponding to the first motion.

5. The method according to claim 1, where the validating the first metadata comprises:
obtaining location data of the first camera during the recording of the digital video;
determining if the detected motion of the first metadata is of a likely activity to be performed at a geographic location specified by the location data based on pre-stored reference locations for likely activities;
changing first metadata to be designated as validated if the detected motion is determined to be of the likely activity; and
reanalyzing recorded motion data stored with the recorded digital video if the detected motion is determined not to be of the likely activity so as to redetect the detected motion to be a validated motion when a motion pattern for the detected motion substantially matches a corresponding one of the plurality of pre-stored reference motion patterns specific to a likely activity to be performed at the geographic location.

6. The method according to claim 1, where the validating the first metadata comprises:
obtaining location data of the first camera during the recording of the digital video;
determining if the detected motion of the first metadata is of a likely activity to be performed at a geographic location specified by the location data based on pre-stored reference locations for likely activities;
adding likely activity as second metadata to the recorded digital video if the detected motion is determined to be of the likely activity; and
reanalyzing recorded motion data stored with the recorded digital video if the detected motion is determined not to be of the likely activity so as to redetect the detected motion to be a validated motion when a motion pattern for the detected motion substantially matches a corresponding one of the plurality of pre-stored reference motion patterns specific to the likely activity to be performed at the geographic location.

7. The method according to claim 1, further comprising:
adding other sensor data from an other sensor within the first camera as second metadata associated with the digital video captured stored in the first memory.

8. The method according to claim 7, wherein the other sensor is a global positioning chip and the other sensor data of the second metadata is global positioning coordinates.

9. The method according to claim 8, where the validating the first metadata comprises:
determining if a detected motion of the first metadata is of a likely activity to be performed at a geographic location specified by global positioning coordinates based on pre-stored reference locations for likely activities;
changing first metadata to be designated as validated if the detected motion is determined to be of the likely activity; and
reanalyzing recorded motion data stored with the recorded digital video if the detected motion is determined not to be of the likely activity so as to redetect the detected motion to be a validated motion when a motion pattern for the detected motion substantially matches a corresponding one of the plurality of pre-stored reference motion patterns specific to the likely activity to be performed at the geographic location.

10. The method according to claim 8, where the validating the first metadata comprises:
determining if the detected motion of the first metadata is of a likely activity to be performed at a geographic location specified by the global positioning coordinates based on pre-stored reference locations likely activities;
adding likely activity as third metadata to the recorded digital video if the detected motion is determined to be of the likely activity; and
reanalyzing recorded motion data stored with the recorded digital video if the detected motion is determined not to be of the likely activity so as to redetect the detected motion to be a validated motion when a motion pattern for the detected motion substantially matches a corresponding one of the plurality of pre-stored reference motion patterns specific to the likely activity to be performed at the geographic location.

11. The method according to claim 1, wherein the movement sensor is an accelerometer located within the first camera.

12. The method according to claim 1, wherein the movement sensor is external to the first camera and is wirelessly connected to the processor located within the first camera.

13. The method according to claim 1, further comprising:
recording other digital video data during the action of the activity with a second camera as other recorded digital video.

14. A method for providing digital video with data identifying motion, comprising:
recording digital video data during an activity from an imager to a first memory within a first camera as first recorded digital video;
recording motion data from a movement sensor as the action is performed by a person or by an object used by the person during the activity along with the recorded digital video in the first memory, wherein the movement sensor is coupled to the person performing the action or to the object used by the person to perform the action;
automatically analyzing the motion data with a processor to detect a motion during the activity;
adding a detected motion of the automatically analyzing as first metadata to the first recorded digital video;
adding second metadata to the first recorded digital video; and
validating the first metadata as a motion of the activity based on the second metadata.

15. The method according to claim 14, wherein the second metadata is global positioning coordinates.

16. The method according to claim 15, where the validating the first metadata comprises:
determining if a detected motion of the first metadata is of a likely activity to be performed at a geographic location specified by global positioning coordinates based on pre-stored reference locations for likely activities;
changing first metadata to be designated as validated if the detected motion is determined to be of the likely activity; and
reanalyzing recorded motion data stored with the recorded digital video if the detected motion is determined not to be of the likely activity so as to redetect the detected motion to be a validated motion when a motion pattern for the detected motion substantially matches a corresponding one of the plurality of pre-stored reference motion patterns specific to the likely activity to be performed at the geographic location.

17. The method according to claim 15, where the validating the first metadata comprises:
determining if the detected motion of the first metadata is of a likely activity to be performed at a geographic location specified by the global positioning coordinates based on pre-stored reference locations for likely activities;
adding likely activity as third metadata to the recorded digital video if the detected motion is determined to be of the likely activity; and
reanalyzing recorded motion data stored with the recorded digital video if the detected motion is determined not to be of the likely activity so as to redetect the detected motion to be a validated motion when a motion pattern for the detected motion substantially matches a corresponding one of the plurality of pre-stored reference motion patterns specific to the likely activity to be performed at the geographic location.

18. The method according to claim 14, wherein the second metadata identifies the activity.

19. The method according to claim 18, where the validating the first metadata comprises:
determining if the detected motion of the first metadata is of the identified activity;
changing first metadata to be designated as validated if the detected motion is determined to be of the identified activity; and
reanalyzing recorded motion data stored with the recorded digital video if the detected motion is determined not to be of the identified activity so as to redetect the detected motion to be a validated motion when a motion pattern for the detected motion substantially matches a corresponding one of the plurality of pre-stored reference motion patterns specific to the identified activity.

20. The method according to claim 19, wherein the movement sensor is an accelerometer located within the first camera.

21. The method according to claim 19, wherein the movement sensor is an accelerometer located external to the first camera and is wirelessly connected to the processor located within the first camera.

22. The method according to claim 14, further comprising:
recording other digital video data during the action of the activity with a second camera as other recorded digital video.

23. A system for providing digital video with data identifying motion, comprising:
an imager for recording digital video data of an action performed by a person during an activity to a first memory within a first camera;
a movement sensor for recording motion data along with a recorded digital signal as the action is performed by a person or by an object used by the person during the activity, wherein the movement sensor is coupled to the person performing the action or to the object used by the person to perform the action;
a first memory within the first camera for storing the digital video data from the imager and the motion data from the movement sensor;
a first processor within the first camera to automatically analyze the motion data to detect a first motion, which corresponds to one of a plurality of reference motion patterns stored in the first memory, during the activity and to add first and second metadata to the recorded digital video stored in the first memory during the activity, wherein the first metadata designates an interval within the recorded digital video corresponding to the detected first motion;
and a second processor using the second metadata to validate the first metadata as a motion of the activity.

24. The system according to claim 23, further comprising:
an other sensor within the first camera for adding other sensor data as the second metadata to the recorded digital video stored in the first memory during the activity.

25. The system according to claim 24, wherein the other sensor is a global positioning chip and the other sensor data of the second metadata is global positioning coordinates.

26. The system according to claim 23, wherein the movement sensor is an accelerometer located within the first camera.

27. The system according to claim 23, wherein the movement sensor is an accelerometer located external to the first camera and is wirelessly connected to the first processor located within the first camera.

28. The system according to claim 23, further comprising:
a second camera recording other digital video data during the action of the activity.
